(19) United States
(12) Patent Application Publication
(10) Pub. No.: US 2004/0117213 A1
(43) Pub. Date: Jun. 17, 2004

(54) System and method for selective and detailed delivery of information over a network

(76) Inventors: Eugene P. Pache JR., Omaha, NE (US); Galen M. Smallen, Arlington, TX (US)

Correspondence Address: BLACKWELL SANDERS PEPER MARTIN LLP, TWO PERSHING SQUARE, 2300 MAIN STREET, SUITE 1000, KANSAS CITY, MO, 64108, US

(21) Appl. No.: 10/724,408

(22) Filed: Nov. 26, 2003

Related U.S. Application Data
(60) Provisional application No. 60/429,796, filed on Nov. 27, 2002.

(51) Int. Cl. G06F 17/60

(52) U.S. Cl. 705/2

(57) ABSTRACT

A system and method for providing integrated websites and pages, and managing the creation, delivery and interface of specific content material to end users. The present invention presents, tracks and manages various aspects of content delivery using a customer centric paradigm. An integrated framework is utilized to provide a consistent and efficient presentation of content relating to particular items of interest to an end user such as a patient. An embodiment of the invention is directed to an online disease specific, secure integrated information repository and communication for patients in need of medical consults.

### BACKGROUND OF THE INVENTION

1. Field of Invention

The present invention relates to a Content Delivery Foundation (CDF) supported by four web based building platforms that facilitate the delivery of specific information to end users. The four web-based building platforms include a Delivery Engine (CDF-DE), a Management System (CDF-MS), Patient-Physician-Interface Consult System (CDF-PPICS) and a Search Engine Optimization Micro-Website Builder (CDF-SEOMWB). An embodiment of the invention is directed to an online disease specific, secure integrated information repository and communication for patients in need of medical consults. The four platforms are focused on providing health care information and treatment options to patient and caregivers.

2. Background Art

An integral part of today's society revolves around healthcare, particularly ready access to such care. Today there is a vast amount of information that is accessible to patients with disease specific conditions. However, there tends to be such a large quantity of data that it becomes difficult to locate specific and targeted medical information. While such a situation might be acceptable for most inquiries, it is particularly problematic in the case of healthcare.

Critical to today's health environment is patient relevant disease specific information. Whether that is simply presenting information, responding to a specific patient's request and analyzing symptoms, developing treatment options or just responding to questions, a system is required that provides information relevant to a specific patients' disease condition for accurate responsive decision making or simply just for patient peace of mind.

Based on the characteristics and preferences of consumers looking for health information, an ideal online resource for patients can be designed. A consumer-focused website should provide users with helpful disease and treatment information, which may serve to foster brand loyalty to the sponsoring company. Product-specific information should also be included on the site for consumers to present to their physician. The immediate goal of the content provided on an online resource is to add value to different aspects of the patient-physician interaction, particularly the treatment decision-making process any product-specific information to be presented to physicians should be both accurate and balanced. An online resource for patients should offer features that drive users onto the site on a regular basis.

The patient-physician relationship has changed dramatically over the last seven years as the penetration of the Internet has increased. The convenience and efficiency of accessing health information online has enabled patients to educate themselves and become more proactive in their own healthcare management. By presenting product-specific information to their doctor, empowered patients can potentially influence physician prescribing decisions. Considering the growing challenge of presenting physicians with product information, investments to maximize the influence of online resources on the patient-physician relationship should be considered.

Current practice includes a web-based electronic patient-provider interface (ePPi) to enhance patient relations and improve the health of practice members. The solution enables patients to stay informed and take a proactive role in getting and remaining healthy, while the physician is able to continue communications with the patient beyond the office visit. In addition, payers, pharmacy benefits managers (PBMs) and other affiliates of the health plan can be part of the Web-based communications network, leading to a team approach for maintaining the patient's health. And it's all done through a secure, personalized home page where each patient can access information based on their visits with their own doctor. The pages are populated automatically by relating content to data that is entered into the practice scheduling and billing system.

That content is displayed in a password-protected, dynamically created Web page where the patient can retrieve a library of pertinent information specific to their health condition, diseases or diagnosis. And, it's a two-way street, so the patient can share information with the physician, which can improve care substantially.

With the ePPi, patients can forward questions via e-mail to their physicians without tying up phone lines and valuable time needed for physicians to care for patients in person. And all this is available for the patient, seven days a week, 24-hours a day. The result is more informed patients who actively participate in their own care.

The Health Insurance Portability and Accountability Act (HIPAA) presents the healthcare industry with a challenge for assuring security and auditing usage of patient information. Coupled with that is the cost of producing and distributing reports

Presently, there are numerous sources or avenues for a consumer seeking healthcare related information. The problem, however, is that such information sources put out only general information. In other words, the consumer is typically not able to locate information that is exactly specific to their respective condition. This scenario is particularly more troublesome when, for instance, a consumer is seeking information relating to specific disease conditions or symptoms. In such a case, some form of consultation with a medical expert is necessary.

Traditionally a consumer in need of specific information may ask his/her primary care physician for a referral either during the course of an office visit or by special request to a health care organization or health insurance company. Once referral for a specialist is obtained, the consumer must then attempt to make contact via telephone, which may lead to a series of selections from an automated telephone menu. The selections may culminate in contact with an intaker provided the call, which is of a non-emergency nature, is made during regular office hours.

An intaker would typically assess the consumer's complaints or symptoms and derive a condition for that consumer. While this may be satisfactory for some consumers, the fact remains that a majority of consumers do not want to wait until regular office hours. Concerns over medical matters arise at all hours. Further still, some individuals may just be interested in an alternate opinion or have a specific inquiry about their condition or that of a loved one. In all of these cases, the consumer would benefit from being able to access information that is specifically targeted to their condition and even better, the consumer would derive significant benefit from direct contact with a physician who specializes in the field.

Prior art systems that have attempted to address these issues have primarily consisted of solitary solutions to specific areas of concern. In other words, these prior art solutions have typically been very generic in nature and not focused on the very particular and specific needs of patients. While some graphical based systems have been implemented, they are not patient centric and are not integrated. They also do not provide comprehensive information flow management features.

Online medical diagnosis or physician referral systems that are in place today can be inconsistent. Further, such systems do not provide the needed flexibility and management required to provide secure one-on-one consultation or interface to patients.

Further exacerbating the patient's procurement of needed specific medical information is the fact that 42 million people or 15% of the population has no medical insurance. Their access to board-certified specialists becomes very difficult. There is a need for an inexpensive method whereby uninsured patients can obtain certified consultations.

Accordingly, there exists a need for a system and method for providing secure, reliable and easily accessible interaction between physicians and patients. This is particularly more paramount because the success of any patient-physician consult interface is heavily intertwined with its flexibility, ease of use and the patient's perspective of the responsiveness and targeted nature of the information that such patient receives.

Furthermore there is a need for automated search engine optimization tools to enable the maximum number of patients and caregivers to find the information provided by the invention.

### BRIEF SUMMARY OF INVENTION

The present invention is directed to a system and method for providing through content management, content delivery, and integrated website and page building, specific and targeted sites that are search engine relevant. In the preferred embodiment of the present invention there is provided a system and method for use in a computing environment to deliver, track, present and manage various aspects of physician and patient interaction in a patient centric environment.

The present invention provides a secure interface for communication between a patient and physician. After an initial registration with a service, a patient is able to present questions about their specific medical condition that will be answered by anyone of a number of physicians that are board-certified in the related medical discipline.

In the preferred embodiment of the present invention, a content management and work flow management system is provided to allow the definition and creation of multiple disease specific, content relevant websites, the editing and updating of these website's contents and the facilitation of online patient physician consults.

A Micro Website Builder (MSB) is also provided which allows the creation of HTML websites that are relevant to specific topics. This tool enables quick access to relevant and specific LifeCenter information and attracts visitors to specific targeted content.

These and other advantageous features of the present invention will be in part apparent and in part pointed out herein below.

### BRIEF DESCRIPTION OF THE DRAWINGS

For a better understanding of the present invention, reference may be made to the accompanying drawings in which:

FIG. 1A illustrates an exemplary operating environment for the system and method of the present invention;

FIG. 1B is a block diagram illustrating the components of the present invention;

FIG. 2A is an exemplary illustrating the choices that may be available to a user after selecting one of the medical LifeCenters in the preferred embodiment of the present invention;

FIG. 2B illustrates the breaking news section of the Cancer LifeCenter;

FIG. 2C illustrates some options that may be presented to a patient after selecting to view medical videos at the Cancer LifeCenter;

FIG. 2D illustrates the Question and Answer section of the Cancer LifeCenter;

FIG. 3A is an illustration of the options and tools that are available to an administrator of the system of the present invention;

FIG. 3B is an illustrative welcome page as seen by an administrator;

FIG. 3C is a flow diagram illustrating functions that may be performed by an administrator in the present invention;

FIG. 4A illustrates the listing of articles as viewed through the content manager tool of the present invention;

FIG. 5A is a flow diagram of the content delivery process of the present invention;

FIG. 5B is an illustrative screen shot of a tree view of a diagnostic tool in the present invention;

FIG. 5C is an illustrative screen shot of a trace text view of the diagnostic tool of FIG. 5B;

FIG. 6A is a flow diagram of an option of patient-physician interface component of the present invention;

FIG. 6B is a flow diagram of another option of the component of FIG. 6A;

FIG. 7A illustrates a patient question and response summary that may be seen by a physician;

FIG. 7B is a flow diagram illustration of a physician's response process;

FIG. 8A is an illustrative flow diagram of the MicroWeb site builder component;

FIG. 8B is an illustrative diagram of the process and data flow of the website builder component of FIG. 8A;

FIG. 9A illustrates a site setup screen for the site builder option of the MicroWeb tool;

FIG. 9B illustrates a site page definition for the site builder option of the MicroWeb tool;

FIG. 9C illustrates a site link definition for the site builder option of the MicroWeb tool;

FIG. 10A illustrates a page setup screen for the page builder option of the MicroWeb tool;

FIG. 10B illustrates a page image definition for the page builder option of the MicroWeb tool;

FIG. 10C illustrates a page meta information definition for the page builder option of the MicroWeb tool;

FIG. 10D illustrates configuration of page settings for the page builder option of the MicroWeb tool; and

FIG. 11 is an illustrative screen shot of a web page produced by the MicroWeb tool.

### DETAILED DESCRIPTION OF INVENTION

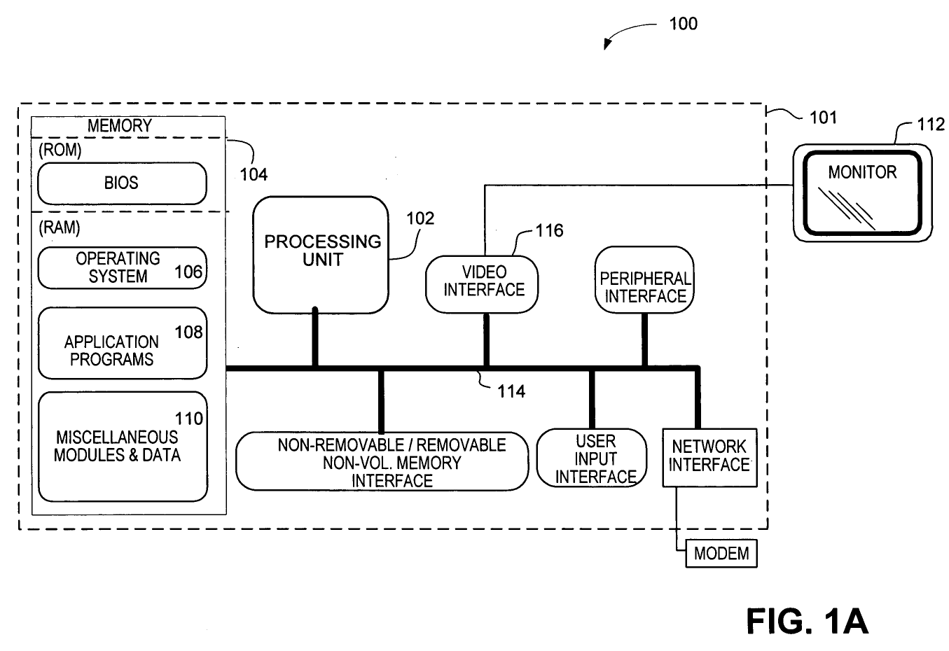

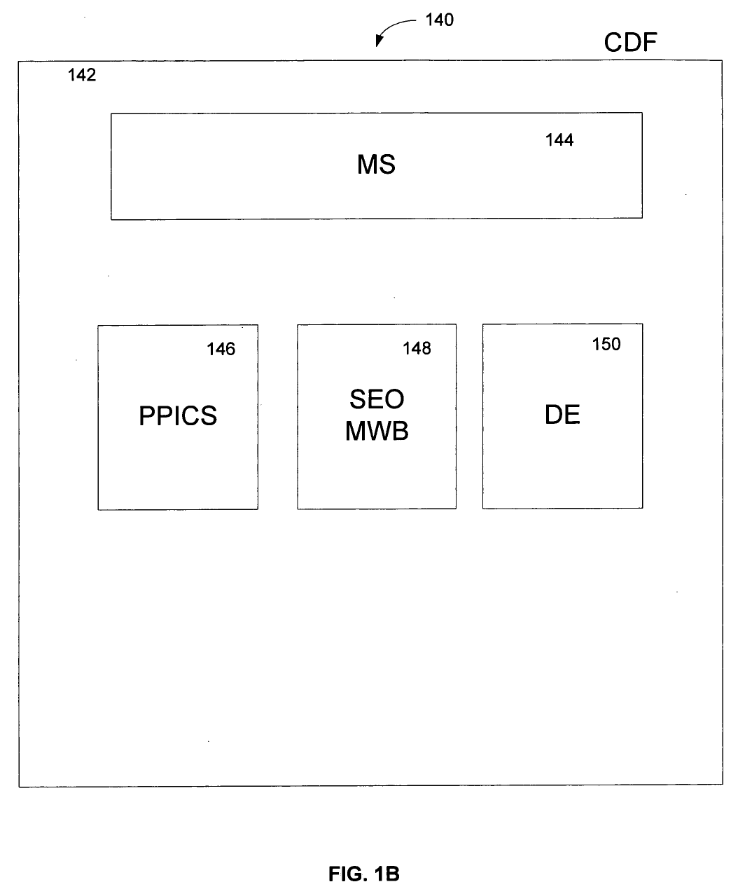

According to the embodiment(s) of the present invention, various views are illustrated in FIGS. 1-11 like reference numerals are being used consistently throughout to refer to like and corresponding parts of the invention for all of the various views and figures of the drawing. Also, please note that the first digit(s) of the reference number for a given item or part of the invention should correspond to the FIG. number in which the item or part is first identified.

The present invention is directed to a system and method for an on-line disease specific, secure and integrated information repository and communication channel for patients in need of medical consults. The present invention will be referenced as a Content Delivery Foundation (CDF) system. It should be understood that the term CDF is utilized to facilitate the discussion and is in no way intended to limit the present invention to any particular version or feature of the named system.

In the preferred embodiment of the present invention, CDF is provided in a network environment such as the Internet and utilizes secure servers and databases in addition to other systems that are common to interactive user systems that are deployed on a network.

The CDF system is implemented to provide disease specific information to patients while also providing a means for a patient to consult directly and electronically with board-certified physicians in a medical area of interest. Further, the present invention also provides a set of administrative tools to facilitate the compilation, coordination, presentation and flow of information that are made available to patients.

The present invention entails a multiple single-point of entry GUI providing integrated access to various disease specific related information for a wide variety of medical conditions as well as access to clinical evaluations, articles on treatments and medications, latest developments, and other such information. Importantly, the information is provided with a disease-centric-paradigm to the patient, thus allowing easier access to relevant information and an opportunity for the patient to participate in their healthcare.

Having briefly provided an overview of the present invention, an embodiment of the invention will be discussed with reference to FIGS. 1-11. An exemplary operating environment for the present invention is first described below.

Referring to FIG. 1A, an example of a suitable computing system environment 100 in which the invention may be implemented is illustrated. The computing system environment 100 is only one example of a suitable computing environment and is not intended to suggest any limitation as to the scope of use or functionality of the invention.

In that regard, the present invention may be described in the general context of computer-executable instructions, such as program modules, being executed by a computer. Generally, program modules include routines, programs, objects, components, data structures, etc. that perform particular tasks or implement particular abstract data types. Those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. When operating in a distributed computing environment, program modules may be located in both local and remote computer storage media including memory storage devices. Additionally, various functions that will be described herein may be implemented by modules that exist wholly or partially on a client system or a server.

The computing environment 100 should not be interpreted as having any dependency or requirement relating to any one or combination of components illustrated in the exemplary operating environment 100.

With reference to FIG. 1A, an exemplary system 100 for implementing the invention includes a general purpose computing device in the form of a computer 102 including a processing unit 102, a system memory 104, and a system bus 216 that couples various system components including the system memory to the processing unit. Importantly, the variant of the computer 102 utilized as the client PC must support a playback mechanism and data rates suitable for high end image rendering.

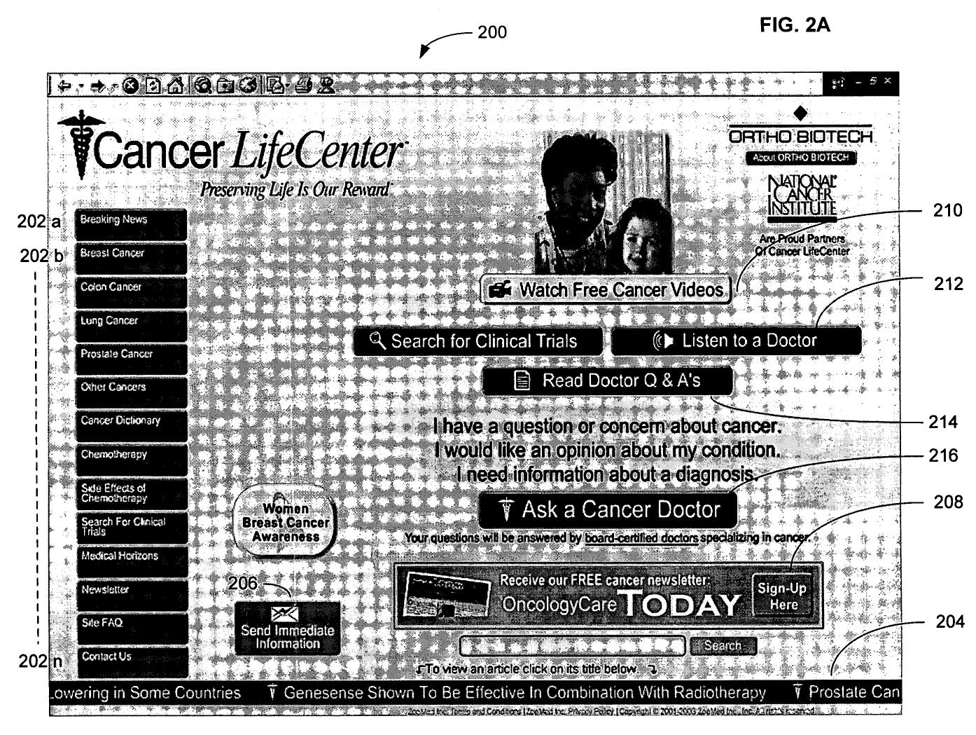

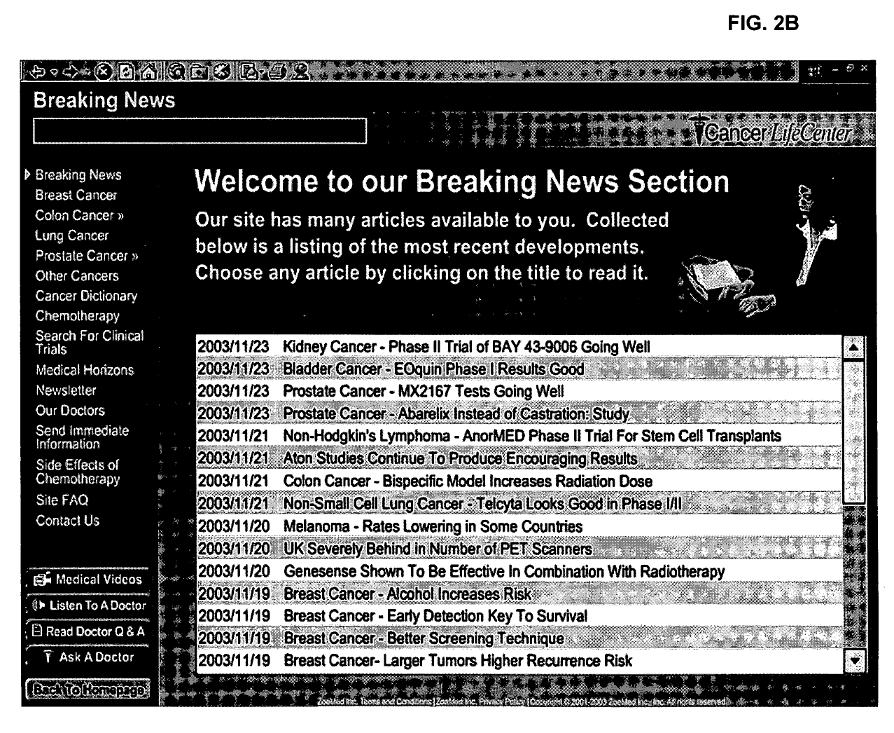

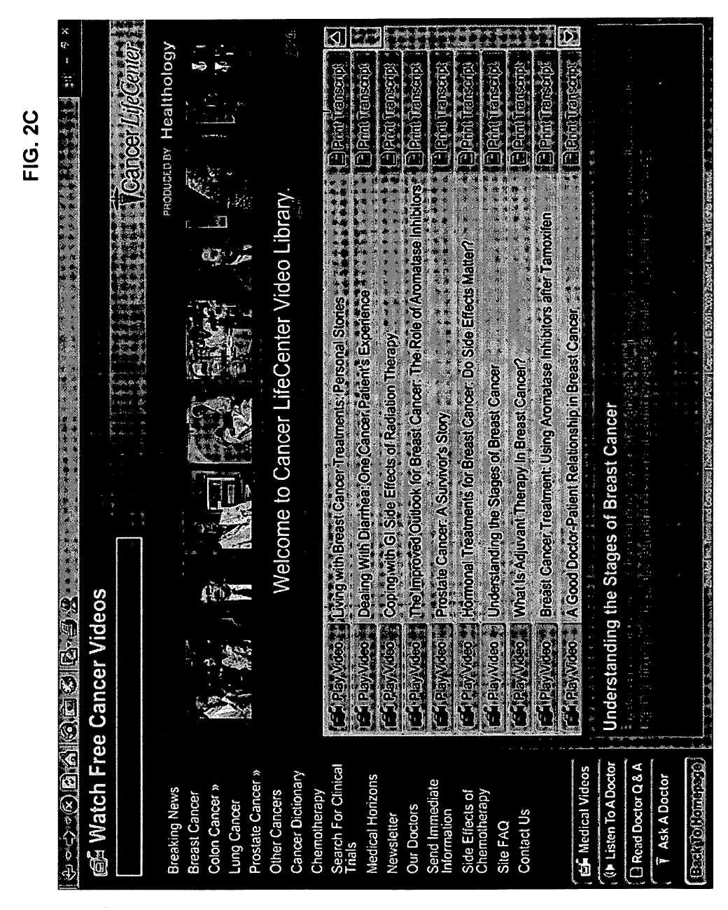

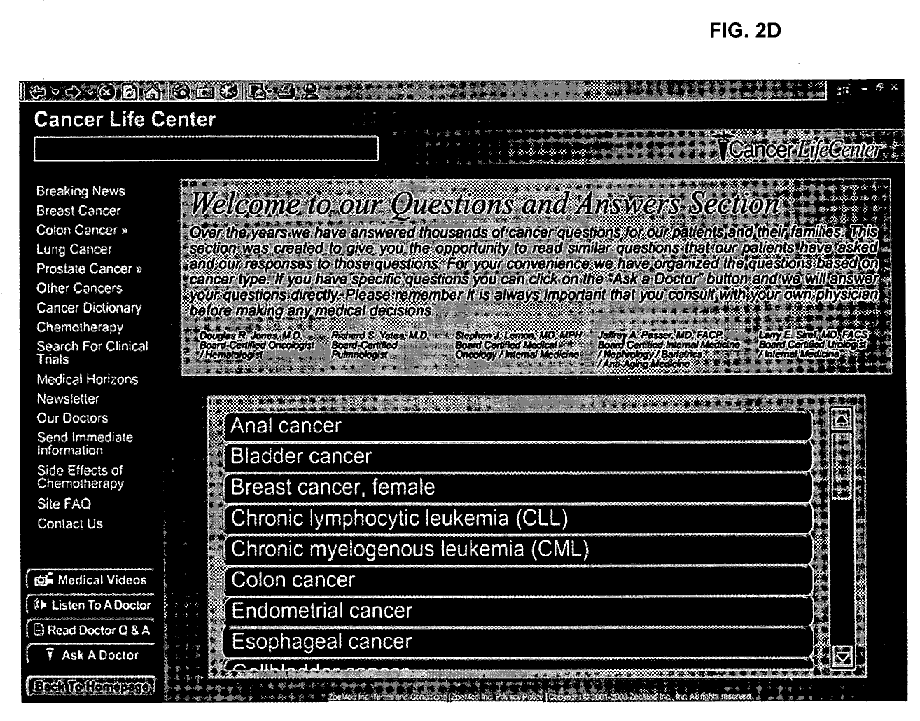

Computer 101 typically includes a variety of computer readable media, which may comprise computer storage media and communication media. The system memory includes computer storage media in the form of volatile and/or nonvolatile memory such as read only memory (ROM) and random access memory (RAM). A basic input/output system (BIOS), containing the basic routines that help to transfer information between elements within computer 101, such as during start-up, is typically stored in ROM. RAM typically contains data and/or program modules that are immediately accessible to and/or presently being operated on by processing unit 102. For illustrative purposes, FIG. 2 depicts operating system 106, application programs 108, and other miscellaneous program modules and data 110.

The computer 101 may also include other removable/non-removable, volatile/nonvolatile computer storage media. Such removable/non-removable, volatile/nonvolatile media may include a hard disk drive, a magnetic disk drive, an optical disk drive, a CD ROM or other optical media. Other removable/non-removable, volatile/nonvolatile computer storage media that can be utilized include, but are not limited to, magnetic tape cassettes, flash memory cards, digital versatile disks, digital video tape, solid state RAM, solid state ROM, and the like.

The drives and their associated computer storage media discussed above and illustrated in FIG. 1A, provide storage of computer readable instructions, data structures, program modules and other data for the computer 101. A user may enter commands and information into the computer 101 through a variety of input devices including but not limited to a keyboard, pointing device, scripting interface, a microphone, joystick, game pad, satellite dish, scanner, or the like. These and other input devices may be connected by other interface and bus structures, such as a parallel port, game port, fire-wire, or a universal serial bus (USB). A monitor 112 or other type of display device is also connected to the system bus 214 via an interface, such as a video interface 216. The computer 102 may also include output devices such as speakers, printers, and the monitor 212, which may be connected through a peripheral interface.

The computer 101 in the present invention operates in a networked environment using logical connections to one or more remote computers. The remote computer(s) may be a personal computer, and typically includes many or all of the elements described above respecting the computer 101. The computer 101 illustrated in FIG. 1A may include connections to a local area network (LAN), a wide area network (WAN) or other networks including the Internet.

When used in a LAN networking environment, the computer 101 is connected via a network interface card (NIC) or adapter. When used in a WAN networking environment, the computer 101 may include a modem or other means for establishing communications over the WAN. In a networked environment, program modules discussed or depicted relative to the computer 101 or portions thereof, may reside in remote memory storage or across multiple devices. It will be appreciated that the network connections shown are exemplary and other means of establishing a communications link between the computers may be used.

Those of ordinary skill in the art will appreciate that there are several other components and interconnections present within a computing environment such as computer 101 and these are well known. Accordingly, additional details concerning the internal construction of the computer 101 will not be discussed in connection with the present invention.

Having provided a broad overview and introduced the environment, devices and nomenclature, the process of the present invention can better be understood and will be discussed with reference to flow diagrams and screen illustrations in FIGS. 1B-7D.

FIG. 1B screen 140 is an illustrative example of the interactive components of the Content Delivery Foundation (CDF) 142. The pieces of the CDF include the Management System (MS) 144, the Patient Physician Interface Consult System (PPICS) 146, the Search Engine Optimization MicroWeb Builder (SEOMWB) 148, and the Delivery Engine (DE) 150. These platform tools interact together to form the foundation framework.

Screen 200 of FIG. 2A presents a patient with a number of choices of information and optional mediums for the delivery of the information relating to cardiac health. In particular, a series of buttons 202a-n enable selection of articles or information on any of a number of labeled subject matter such as, cardiac arrhythmia, cholesterol, and heart attack. Other buttons provide access to more generic information pertaining to the disease such as healthy life style, breaking news, and treatment and medications. For example, a breaking news button 202a provides access to some the latest information that is relevant to the disease, as illustrated in FIG. 2B. At the lower portion of screen 200, a scrolling display 204 of article titles is presented. A patient has the option to choose an article from the display 204. An email request button 206 allows a quick request for information relating to the LifeCenter. Patients can also subscribe to a newsletter about the disease by using the sign-up button 208.

As mentioned earlier, patients are able to access information in a variety of media. Option button 210 allows a patient to select to view any one of a number of videos. Turning to FIG. 2C, a listing of videos is presented to the user along with a description area 222, where a brief description of each video is provided. As shown, a patient may also elect to print the transcripts from a selected video 224.

Returning to FIG. 2A, option 212 allows a patient to listen to a Physician talk about topics relating to a disease. Option 214 allows a patient to view a history of previous questions and answers that where exchanged between patients and physicians, as shown FIG. 2D. Option 216 enables the patient to pose one or more questions to a physician. This aspect of the present invention is able to provide unlimited interaction between the patient and physicians as part of the Patient Physician Interface Consult System (CDF-PPICS) and will be discussed later.

In an embodiment of the present invention, a tool is provided to simplify the search and selection of applicable clinical trials to a patient's respective disease condition. In operation, an XML feed is provided by a third party such as the National Cancer Institute. The data is parsed and categorized to facilitate identification and search within the CDF System. A patient can obtain data by locating a keyword, e.g. disease type.

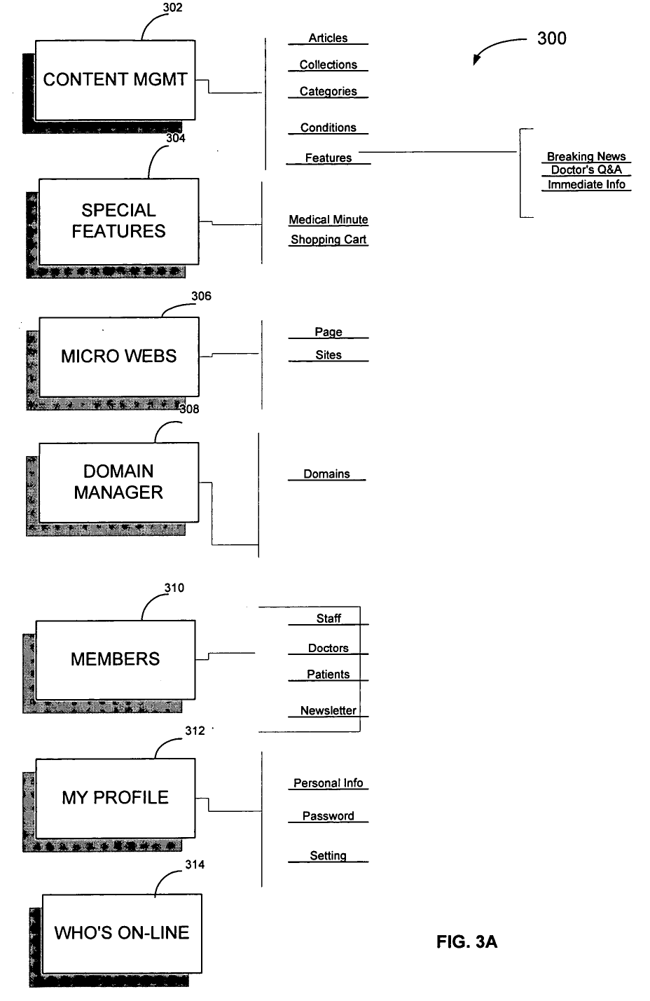

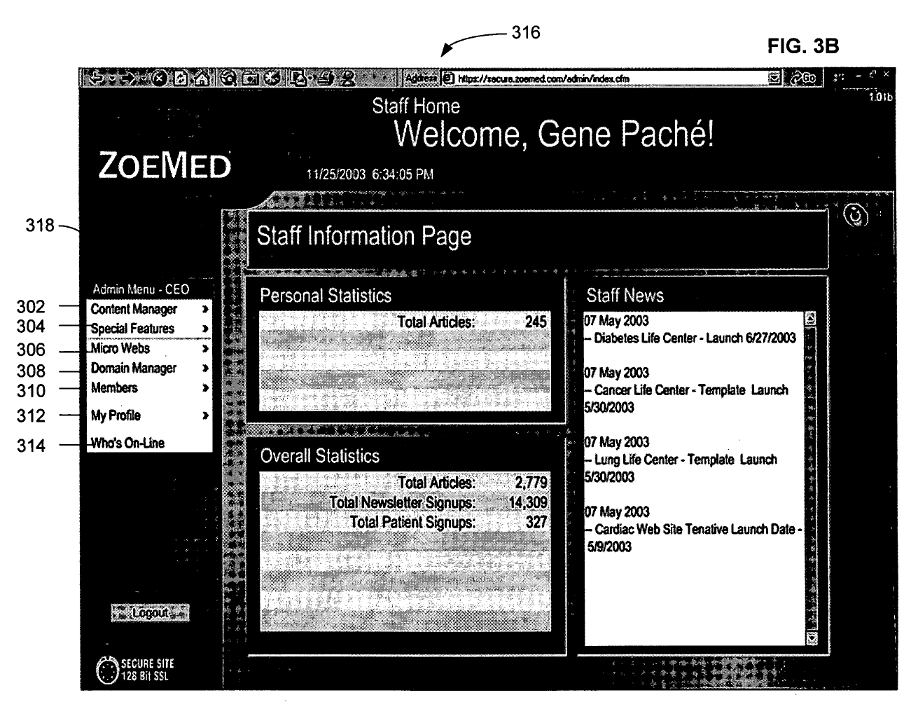

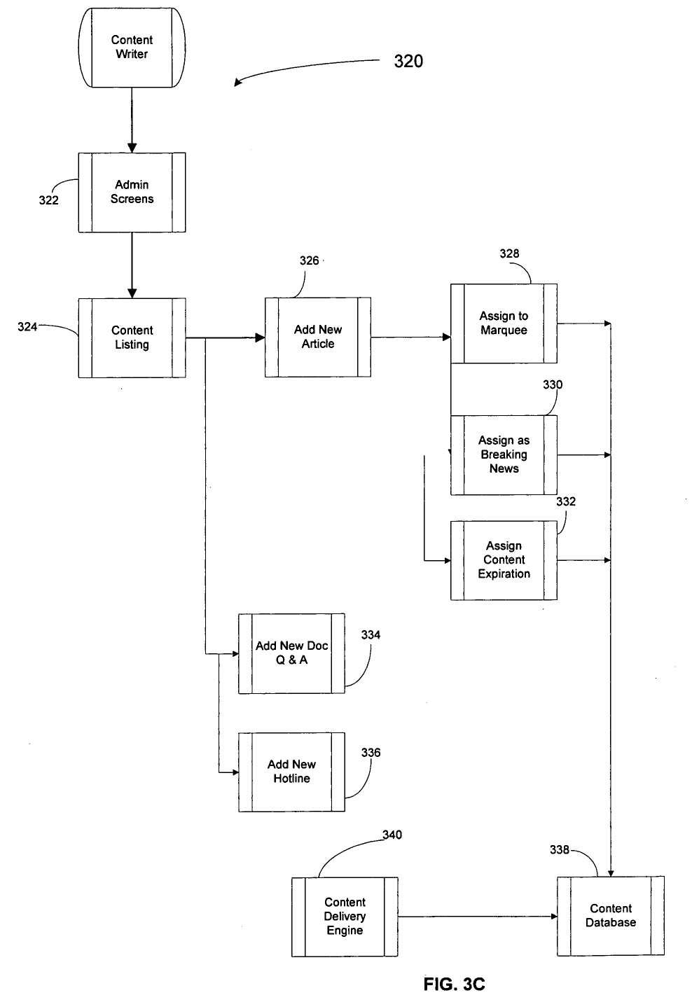

The creation, publishing, and updating of medical information on each disease specific center requires a sophisticated content management system which includes content entry and manipulation, portal management, user management, and application monitoring. Options and tools that are available to an administrator (manager of content) of the CDF system of the present invention are illustrated and referenced as tool options 300 in FIG. 3A. Turning to FIG. 3B, in an administrator welcome screen 316 is displayed, and the tool options 300 are provided as options in the Admin menu 318. Each of the options 318 allows the performance of unique functions and features of the present invention. As shown, there is a Content Management 302, Special features 304, Micro Web 306, Domain manager 308, Members 310, My Profile 312 and who's on-line 314. More particularly, the tool options 300 provide a framework for the development and management of the previously discussed end-user interface.

When an administrator enters the system of the present invention, certain statistical information that would be of interest may be displayed. For example and as shown in FIG. 3C, there may be a sample welcome page 316 in which personal statistics, overall statistics and staff news are displayed. Additionally, there may also be a display of an administrative menu 318 from which the earlier recited variety of tools can be accessed.

Special features 304 enables the administration of medical minutes and a shopping cart. In other words, an administrator can locate and identify articles from medical journals that will be presented to patients on any of the LifeCenters.

My profile 312, allows the administrator to update his/her personal information including password and other system settings.

Content management 302, allows the administrator to manage the informational content of the various LifeCenters or portals, as well as the inter relationship of informational items. The details of content management are best understood by reference to the flow diagram 320 of FIG. 3C.

Turning to FIG. 3C, the content entry and manipulation process of the present invention is illustrated. Importantly, the present invention utilizes a single content table having one format for all content that is utilized in the system. However, content is returned and displayed in multiple ways and formats as described throughout this document. Content is managed in the present invention through a set of administrative screens, at step 322. Through such screens or interface, a listing of content can be manipulated at step 324.

Manipulation of content listing can include tasks such as an administrator electing to add a new article at step 326. In addition to providing the article, the article must also be assigned to a collection. Some exemplary collection assignments in an embodiment of the present invention include assignment to marquee at step 328, assignment to breaking news at step 330, or assignment of content expiration at step 332.

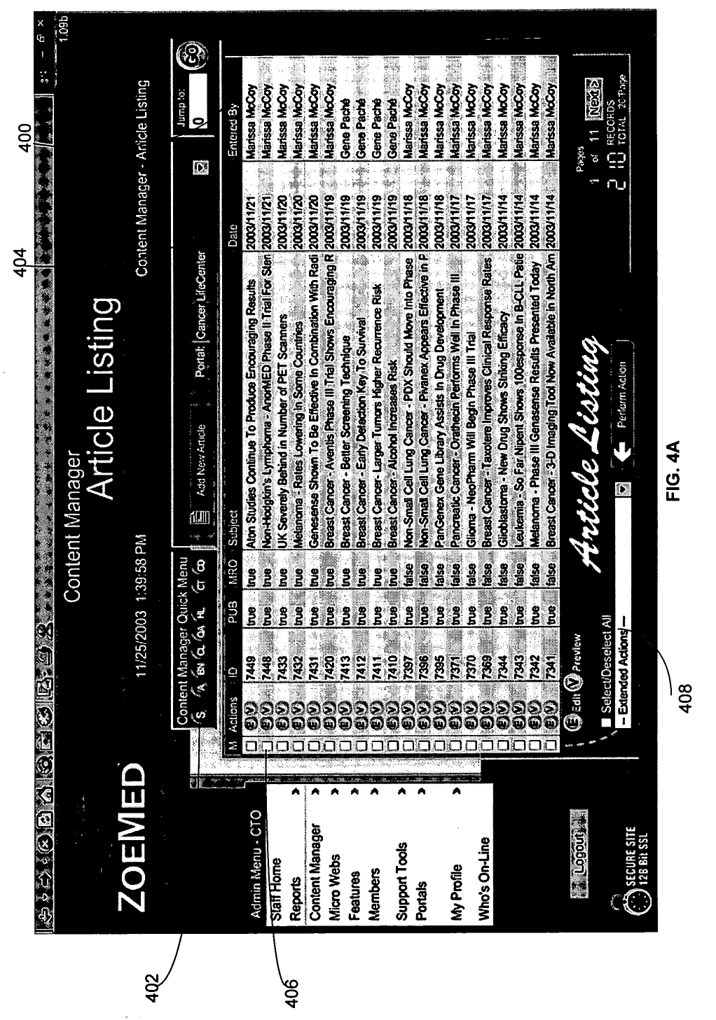

Manipulation of content listing can also include adding a new article such as shown at step 326. An exemplary article listing of such entries is illustrated in FIG. 4A. An article listing window 400 includes a quick menu area 402, portal selection 404, a article list 406, an extended action window 408 and other objects that ease navigation and record maintenance functions.

The quick menu area 402 provides access to articles, collections, categories, conditions and other features such as breaking news, physician question/answer and immediate information. From the accessible options, an administrator for example could add a new article to the system, specify which collection the article should belong to, place the article in one or more categories and specify the conditions under which the article would be displayed or presented to patient user.

The portal selection 404 allows the administrator to specifically access and limit activity to a particular LifeCenter. The article list 406 displays a time stamped and audit compliant listing of the content that have been presented within a selected LifeCenter for edit or preview by the administrator. Ordinarily actions can be performed on individual records of the content list 406 however, through the use of the extended actions window 408, some operations can be performed across multiple entries.

Returning to FIG. 3C, content manipulation can further include the addition of new hotlines such as at step 336. Irrespective of the nature of any content manipulation, the resulting effect is a modification to a single content database table at step 338.

The content database table serves as the source of information for a content delivery engine 340. The content delivery engine which is responsible for handling presenting content in a website format, will be discussed in more detail later in this document.

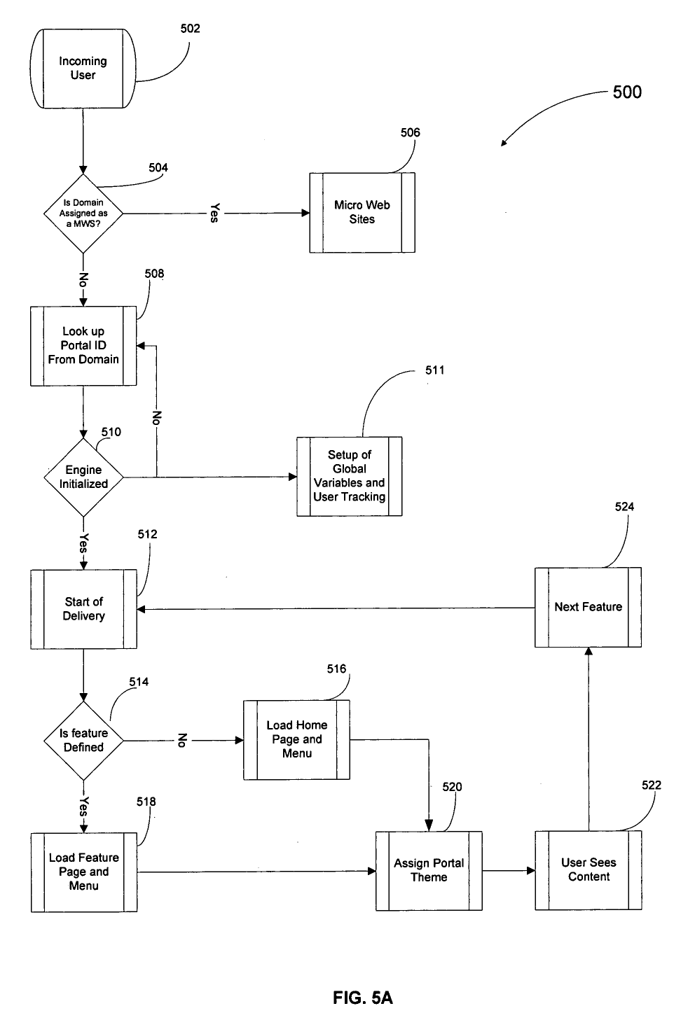

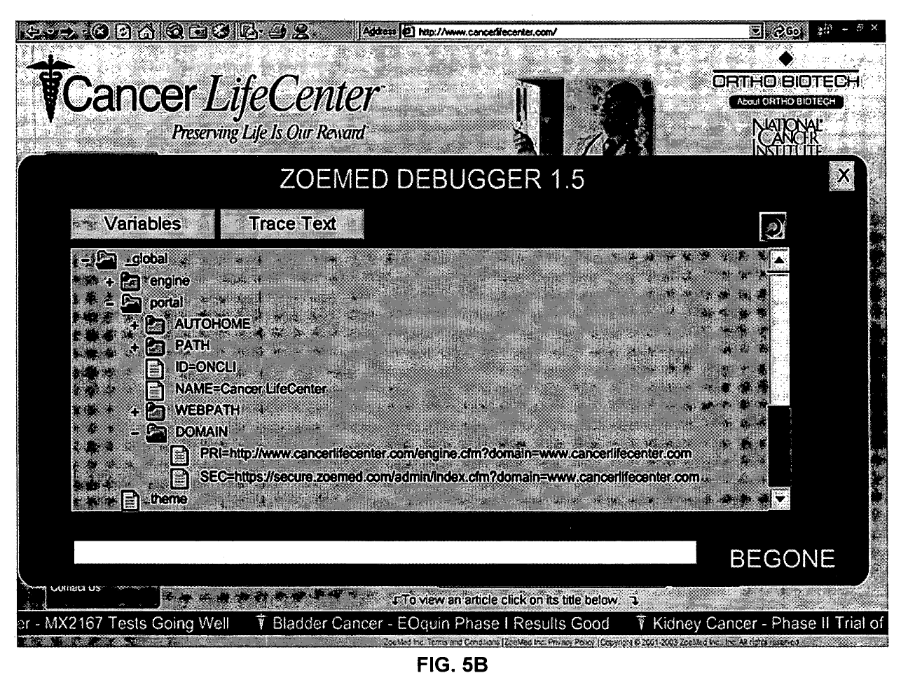

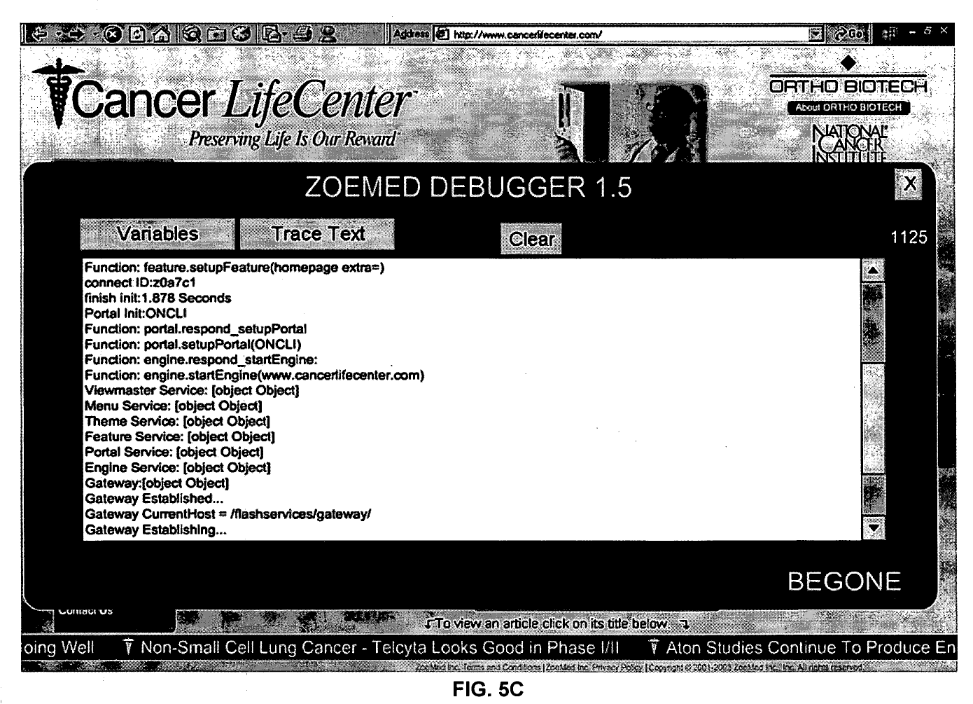

The Delivery Engine (CDF-DE) component of the present invention facilitates the delivery of content. In other words, this component delivers the previously described websites and pages in response to the previously described user interactions. The operations of the content delivery component are best described with reference to the flow diagram 500 of FIG. 5A.

As shown in FIG. 5A, an incoming user at step 502 selects a particular URL. The content delivery component then makes a determination as to whether the domain associated with the URL is assigned as a MicroWeb site, at step 504. If it is the case that there is a MicroWeb site for the URL, then the appropriate MicroWeb site is delivered as shown at step 506. In the primary flow, if a site is not defined as a MicroWeb, a lookup is conducted for a portal identification from the specified domain, at step 508. Next, at step 510, there is a test to determine if the engine of the delivery content has been initialized. Initialization as used herein includes setting up global variable parameters 511, and user tracking for audit purposes. In the event that the engine is not initialized, control is passed back to step 508 for another lookup of the portal identification. If the engine has been initialized then delivery is started at step 512.

In operation, the system and method of the present invention divides content into feature sets, where a feature set is a modular piece of content that obeys the formatting rules of the content delivery engine. As would be understood by one skilled in the art, content can include Macromedia Flash movies or dynamic data that is provided by a content writer, such as earlier described respecting an administrator who has entered and/or manipulated content to include menus, content, colors, and user controls.

A diagnostic tool for monitoring application process work and for communicating the status of program objects to an administrator or other authorized user. As shown in FIG. 5B, a screen of the diagnostic tool is included illustrating a tree view of the global parameters defined by the CDF. FIG. 5C illustrates the trace text that is a communication path for errors and status information.

At step 514, there is first an inquiry into whether or not a feature has been defined for content delivery. If no feature has been defined a home page and menu are loaded at step 516 and then a portal theme is assigned at step 520. Conversely, if a feature is defined, the feature page and menu are loaded at step 518 and then a portal theme is assigned at step 520. Following the assignment of a portal theme, the user is presented with the content at step 522. Additional or subsequent features can be selected at step 524, thereby returning processing to step 512, for the start of delivery of the features.

The Patient Physician Interface Consult System (CDF-PPICS) enables patients to ask disease specific questions about their respective condisiotn and physician response within a secure, HIPAA compliant interface. In order to present a question, a patient must be registered and be assigned a valid identification and password. At the time of initial registration, a patient has the option to select a level of service. For example, patients may elect to sign up for a thirty-day, ninety-day or one-year period during which an unlimited number of questions could be presented and answered by a board-certified physician.

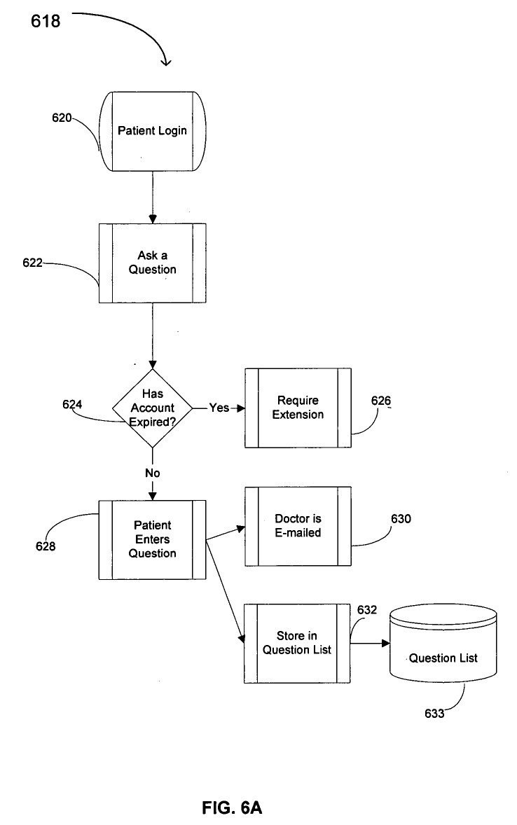

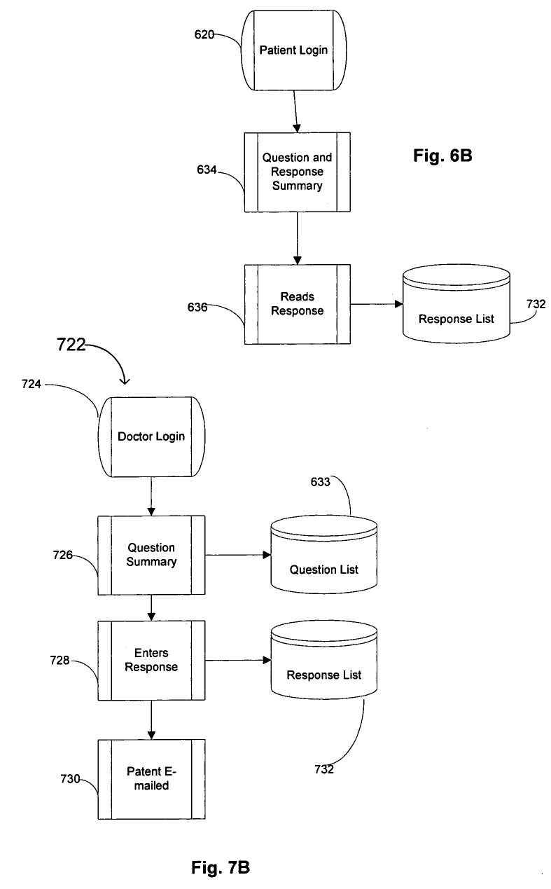

FIG. 6A illustrates a diagram 618, which explains one procedure that occurs after a patient selects the option 216 on screen 200 of FIG. 2A. As shown in FIG. 6A, the patient logs in at step 620 and proceeds to ask a question at step 622. Verification is conducted at that time to determine the validity of the patient's account, at step 624. If the account is expired the patient at step 626 can then initiate an extension of the account. Questions and responses on accounts that have expired are available to the patient and physician without an extension. An extension is only required to ask new questions and receive new responses to said questions. On the other hand, if the account is still valid, the patient may then enter one or more questions, at step 628. An email is then generated to one or more physicians at step 630. The question presented by the patient is stored into a question list storage 633, at step 632. Importantly, the actual questions are not emailed. A reminder or reference to the question is what gets emailed to the physicians.

An alternate procedure following a patient's selection of option 216 on screen 200 of FIG. 2A, is illustrated in FIG. 6B. As shown in FIG. 6B, the patient logs in at step 620 and proceeds to a question and response summary at step 634. If a response is available, the patient is able to read the response at step 636 from a response list storage 732.

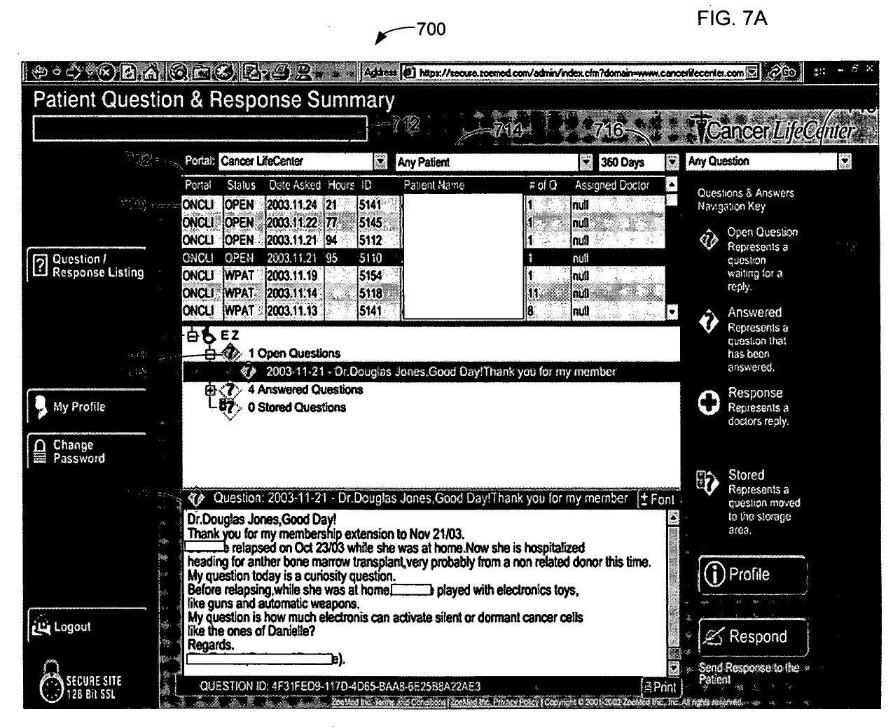

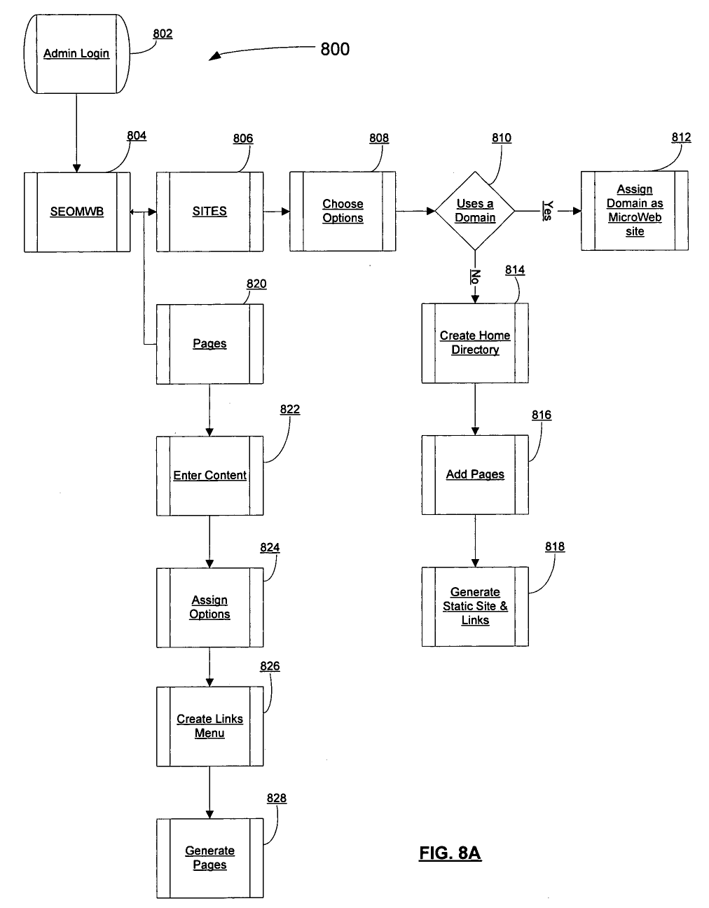

Any one of a number of the board-certified physicians that participate in the service is able to log into the service to view and respond to questions. FIG. 7A illustrates an exemplary interface screen 700 for such physicians. Synopsis entries 720 relating to various questions are presented in a list window 702. Information about any specific patient is displayed in a tree window 704. When a physician selects an entry 720 from the list window 702, the patient's name and other information such as open questions, answered questions etc. are displayed in a tree format in the tree window 704. In an embodiment of the present invention, specific icons are associated with the status of the questions, as illustrated in the navigation key legend 710. Selection of a branch within the tree window 704 displays a time stamped subject line entry 706. When the subject line entry 706 is selected, the question presented by the user is displayed in the question window 708.

Since the PPICS system is able to address multiple diseases through the variety of LifeCenters that were previously discussed, one of the options available to a physician on the interface screen 700 is the ability to select a portal 712 of choice. The selection of a portal 712 limits the entries 720 in the list window 702 of patient questions that are presented to the physician accordingly. The physician may also further limit the entries 720, by selecting any one of a number of additional limiting criteria. A patient selection list 714 allows selection of all patients or specific patients. A days selection 716 allows the selection of the aging of the presented entries 720. A question status selection 718 allows the physician to specify for example if he want a listing of open questions, answered questions and so on.

FIG. 7B illustrates the flow 722 of a physician's interaction with the system of the present invention. In particular, a physician logs in at step 724 and is then presented with the question summaries at step 726, as discussed earlier. Noteably, the question summaries are generated from the question list storage 633 that was discussed in reference to step 632 of FIG. 6A. The physician can then selectively enter a response at step 728. A response to a patient's question causes the patient to be notified by email at step 730 and results in the response being placed in a Response list at step 732, which the patient may then retrieve as previously described in reference to FIG. 6B.

Having described the operation and source for the interface provided to the physician and the patients, as well as how content information is stored and managed, attention will next be focused on how to present relevant, indexable content to search engines which enabled quick access and attracts visitors to specific targeted pages.

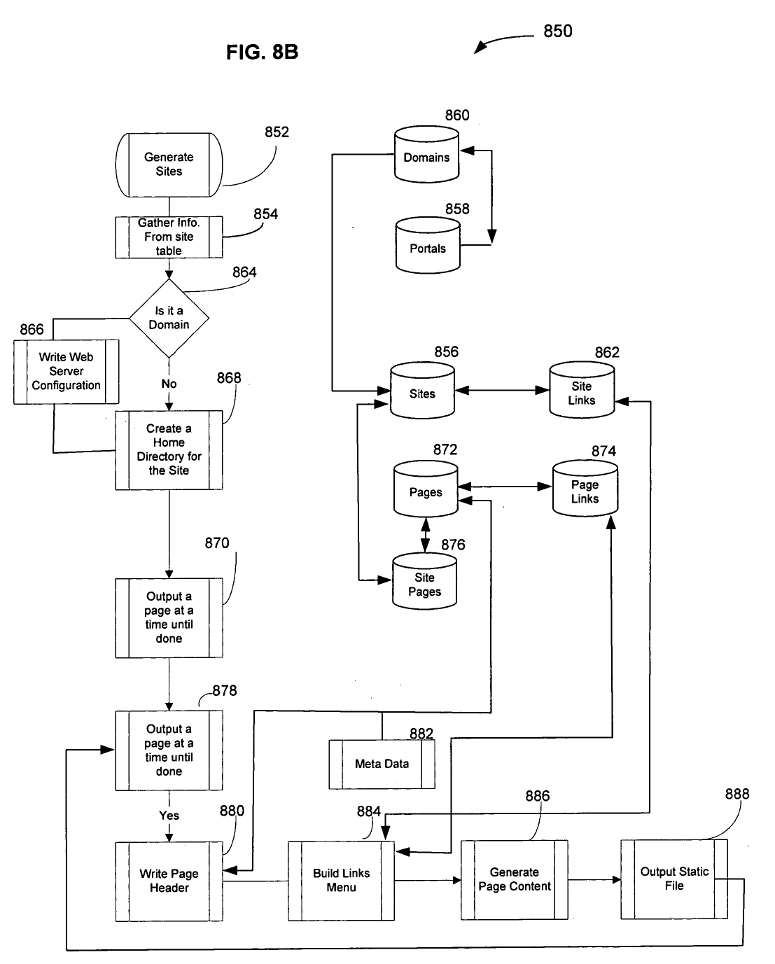

FIG. 8A is an illustrative flow diagram 800 of a website building component of the present invention. The component will be referenced as the Search Engine Optimization MicroWeb Builder (CDF-SEOMWB) or simply MicroWeb Builder, in the preferred embodiment of the present invention. However, it should be understood that such reference is made to aide in the description of the invention and is not intended to limit the described functionality or features of the present invention to any particular product or version of the product.

As previously discussed and illustrated, in FIG. 1B MicroWeb Builder is another one of the administrative tools that is provided to an administrator by the present invention. Returning to FIG. 8A, an administrator must first log into the system at step 802, to gain access to the site builder. Once in the site builder at step 804, the next course of action depends on whether the interest is in working on websites or web pages. Web-site operations require a selection of step 806 and page operations require a selection of step 820.

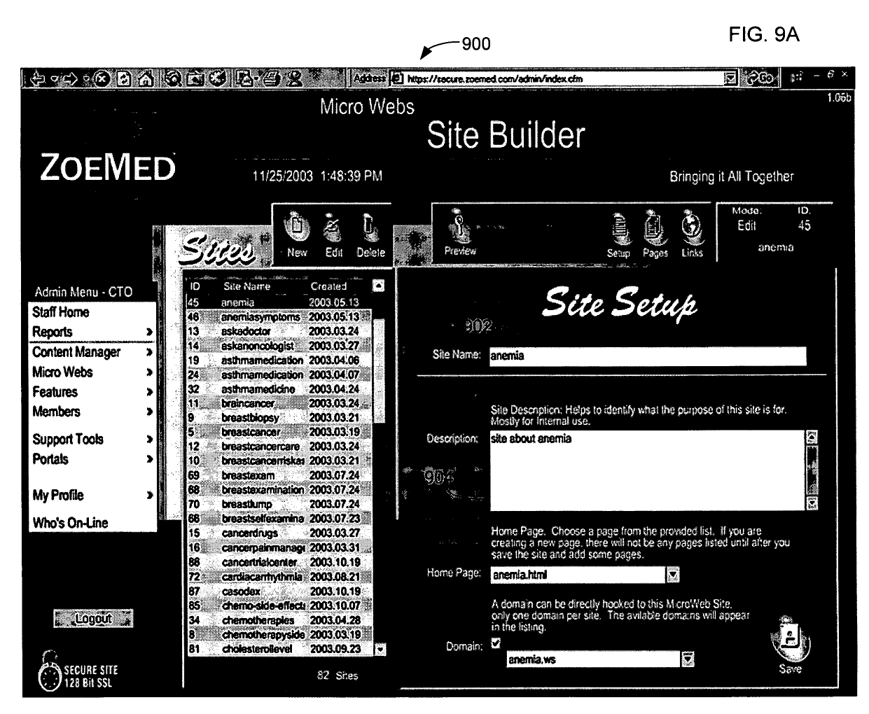

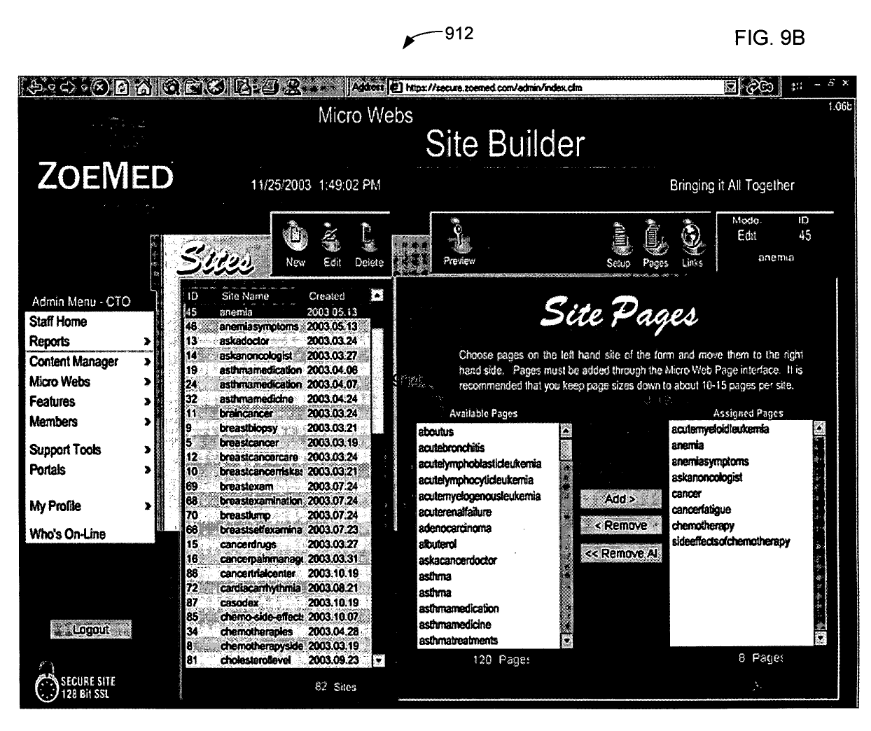

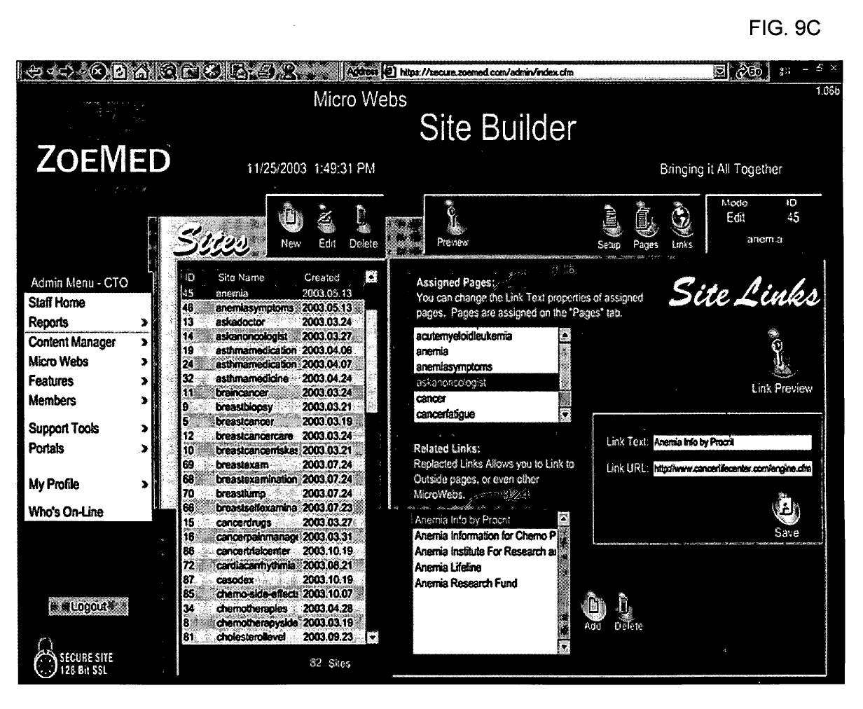

Focusing for the moment on site building which is initiated at step 806, the administrator may then specify one of a variety of options for the site at step 808. For example, FIG. 9A illustrates a site setup screen 900 that may be presented to an administrator. As shown, several parameters relating to the operation of a site may be specified and configured relatively easily. For example, the site setup may include a site name 902, a site description 904, a home page designation 906 and optionally a domain 908.

Returning to FIG. 8A, if the use of a domain is required as determined at step 810 in the site building process, a domain is assigned for the micro website at step 812 before the creation of a home directory at step 814. Alternatively, just a home directory is created at step 814. Once a home directory exists, web pages can then be added to the site as shown at step 816.

Web pages can be added in a manner similar to that, which is illustrated in FIG. 9B, wherein a setup screen 912 for handling site pages is shown. In operation and as shown, an administrator may select the pages that will be designated and assigned to the website from a list of available site pages 914. The selected pages are then transferred to an assigned pages list 916.

Returning to FIG. 8A, after pages have been added at step 816, a static site with links can then be generated at step 818. A site link configuration screen 918 is illustrated in FIG. 9C. An administrator may select a page from the list of assigned pages 916 and then specify a link text 920 and a link Universal Resource Locator (URL) 922 for the page. Additionally, the administrator may also specify a list of related links 924, such as outside pages or other micro websites.

As previously mentioned, the micro website builder may also be utilized to generate web pages as illustrated at step 820 of FIG. 8A. When an administrator is generating web pages, the content for such pages must first be specified at step 822. Following which, options for the page can then be assigned at step 824, such as appearance, size and so on. A menu is presented to enable the creation of links at step 826. Pages can then be generated, at step 828. Notably, the generated pages are made available for the page addition of step 816, which was described with reference to FIG. 9B. The coordinated page and site development of the present invention allows for sites and pages that are relevant and indexable.

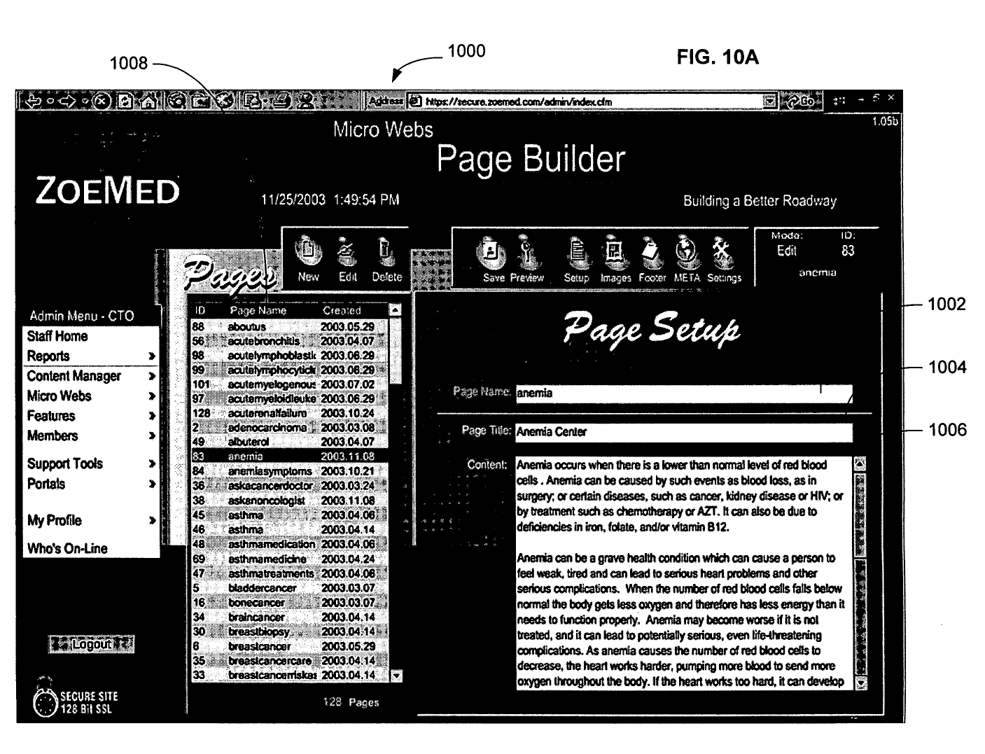

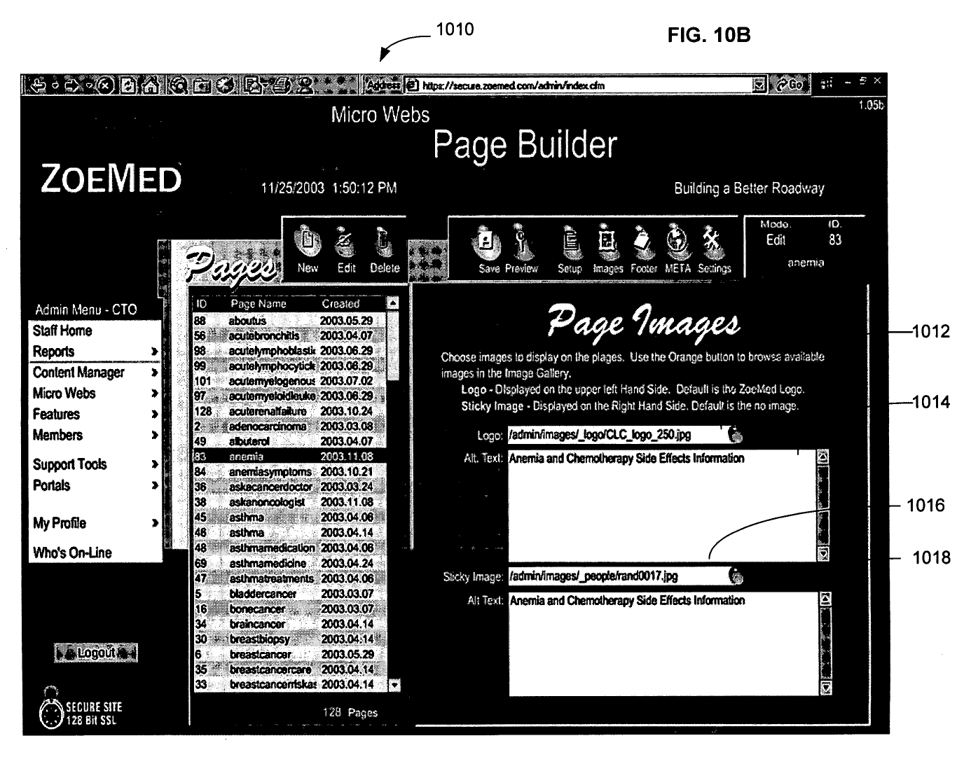

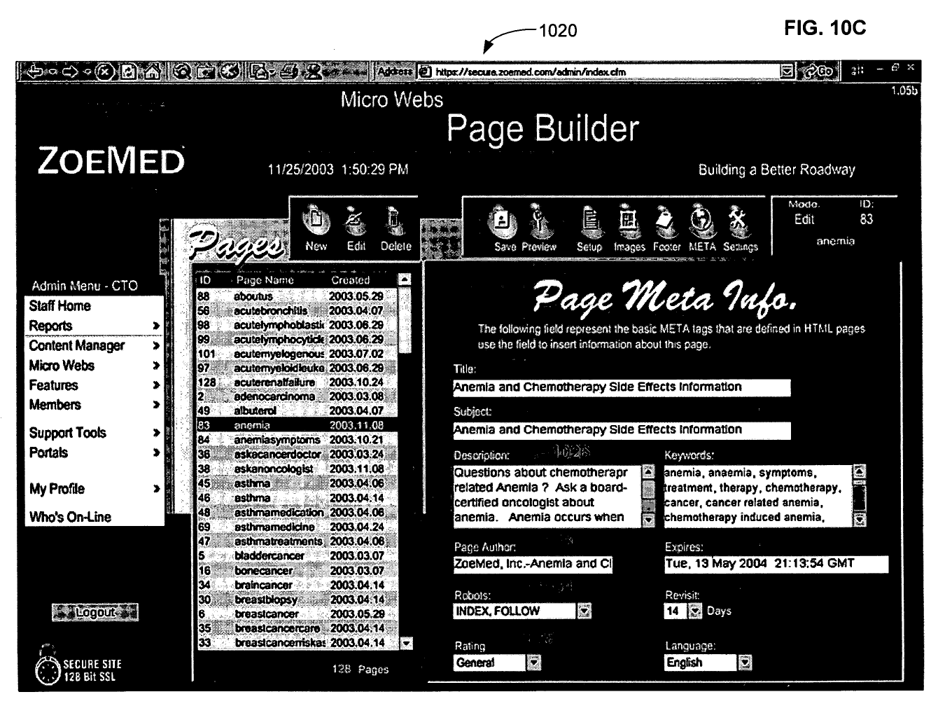

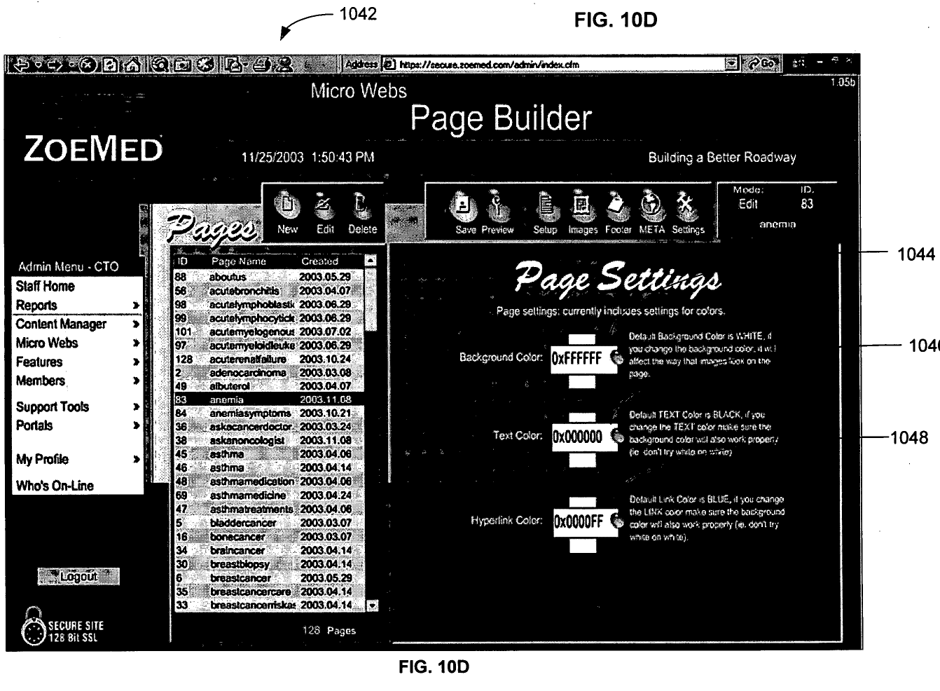

FIG. 10A illustrates an exemplary screen 1000 for building a web page utilizing the website builder application. More particularly, the screen 1000 illustrates some of the options that may be available to an administrator after selecting to administer pages as opposed to websites while using the Microweb site builder. In other words, the screen that is presented when the administrator selected step 820 in the illustrated flow diagram of FIG. 8.

As shown in FIG. 10A, screen 1000 enables page setup including the option to specify a page name 1002, a page title 1004 and page content 1006. Pages are listed in a page list 1008 and can be selected for edit or deletion. Other operations relating to web page appearance and content are also provided through the present invention.

FIG. 10B illustrates an image assignment screen 1010 of an embodiment of the present invention. As shown, an administrator may designate images or text that would appear in various locations on the resulting web page. For example a logo 1012 or alternate text 1014 can be specified for the upper left side of the screen. A sticky image 1016 or other alternate text 1018 can be specified for placement on the right side of the resulting web page. As would be understood by those skilled in the art, such choices or placements may vary without departing from the scope of the invention.

FIG. 1C illustrates how meta tags can be specified for a web page that is being configured by an administrator. As shown, on the page meta screen 1020, some basic meta tags that are predefined could be specified for the web page. In the preferred embodiment of the present invention several meta tag fields are provided as follows: a title 1022, a subject 1024, a description 1026, keywords 1028, page author 1030, expiration 1032, robots 1034, revisit count 1036, rating 1038 and language 1040. It should be understood that the provided meta tags are merely exemplary and that the addition or replacement by other meta tags is anticipated and within the scope of the present invention.

FIG. 10D illustrates further settings that may be specified for any of the pages that are being defined within the MicroWeb site page builder option of SEOMWB. As shown, the page setting screen 1042, includes setting for colors of various components of a web page. Illustrative self descriptive fields such as a background color field 1044, a text color field 1046 and a hyperlink color field 1048, allow an administrator to provide or specify the desired color appearance. The entries made in these color fields and the meta tag fields describe earlier, are utilized at runtime when the web page is presented by a content delivery component of the present invention.

FIG. 8B is an illustrative flow diagram 850 of the website generation component of the previously discussed web builder component, SEOMWB. In particular, the flow diagram 850 illustrates the process and data flow of the details associated with the page generation step identified as step 828 in FIG. 8A.

Sites and Pages that are created with SEOMWB are generated into static HTML pages to facilitate viewing and interaction with standard browsers. The site generation process begins at step 852. At step 854, information is gathered from the sites table 856. The information contained in the sites table 856 includes information from the domains 860 and related portals table 858, which were provided by an administrator or other authorized user. The information in the domain 860 and portal 858 tables provide the association and inter-relationship of portals and domains.

If it is determined at step 864 that the site that is to be generated has been defined to have a domain then an http server configuration file is written at step 866. The server configuration file conforms to a standard format such as for an Apache Web server. Next, irrespective of whether there is a domain association or not, a home directory for the site is created at step 868. The home directory is provided to hold the static pages that will be generated. In order to produce the pages at step 870, page information is gathered from the site pages table 876.

As would be understood by those skilled in the art, there could be multiple pages for each web site. As such the site pages table 876 provides the repository for the correlation between the sites table 856 and the pages table 872. The pages and correlation are added and specified in the respective tables through the SEOMWB Administration as previously described.

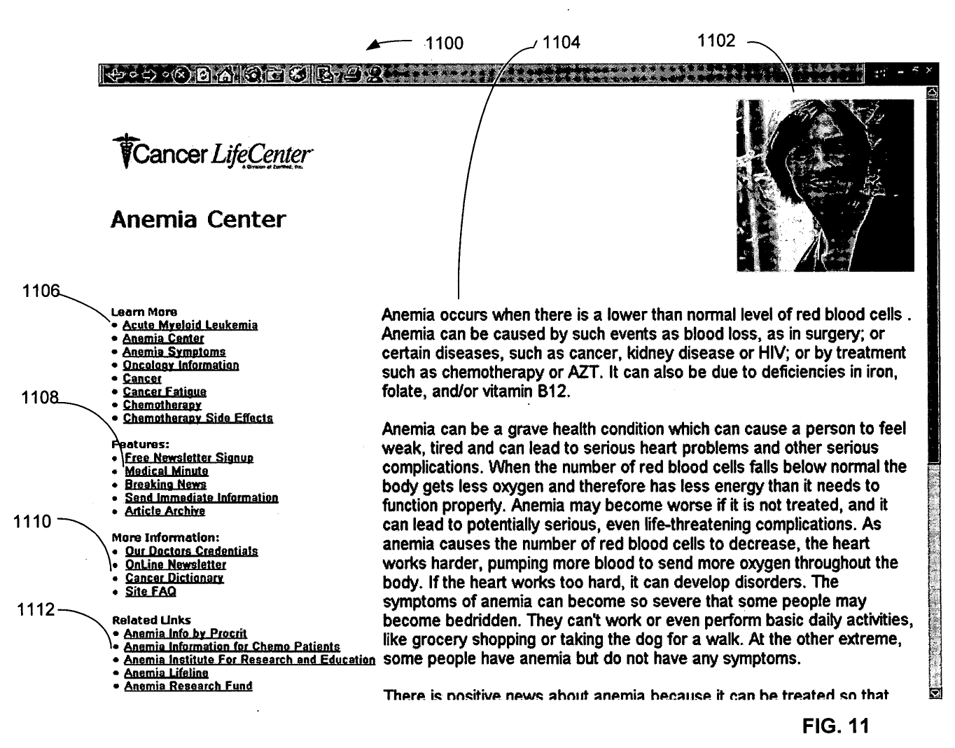

Once all page related information for a site is available, the pages are and built one at a time in a continuous loop as indicated at step 878. For each page, a page header is written at step 880. Also at step 880, Meta data information 882 for each of the pages is incorporate into the information from the pages table 872. Next, a links menu is built at step 884. The links menu is built utilizing information from both the site links table 862 table and the page links table 874. Following this, the actual content of the page is generated, at step 886. The final step for each page is the creation of a static HTML file, at step 888. FIG. 11 illustrates an example of a page 1100 in a site that was generated with the SEOMWB. The site contains an image 1102, content 1104, page links 1106, site links 1108 and 1110, related links 1112, and Meta data contained within the HTML code of the page.

FIG. 11 illustrates an example of a page 1100 in a site that was generated with the SEOMWB. The site contains an image 1102, content 1104, page links 1106, site links 1108 and 1110, related links 112, and Meta data contained within the HTML code of the page.

The various features and screen examples shown and discussed above illustrate the novel features Content Delivery Foundation (CDF) of the present invention. A user of the present invention may choose any of the above features or an equivalent thereof, depending upon the desired application. In this regard, it is recognized that various forms of the subject systems could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the sprit and scope of the present invention.

Other aspects, objects and advantages of the present invention can be obtained from a study of the drawings, the disclosure and the appended claims.

What is claimed is:

1. A method in a computing environment for providing disease specific medical information comprising:
providing access to a registered patient;
providing a secure central data repository;
receiving one or more questions from said patient, storing said questions in said secure central data repository;
receiving a response to said questions from said one or more board certified physicians; and
providing notification of said response to said patient and storing said response in said secure central data repository.

2. A method as recited in claim 1, further comprising providing notification of said questions to one or more board certified physicians

3. A method as recited in claim 1, further comprising compiling a sterilized list of said questions and response for access and viewing by a second patient.

4. A method as recited in claim 1, wherein said questions and response are not actually transmitted between said patient and physicians and are instead securely referenced.

5. A method as recited in claim 3, wherein said sterilized list contains no identifying information of said patient.

6. A method as recited in claim 3, wherein said second patient need not be registered or logged in.

7. A method as recited in claim 1 further comprising providing said patient with unlimited access to said one or more questions and responses.

8. A method as recited in claim 1, wherein condition histories of said registered patient is stored in said secure central data repository.

9. A method in a computing environment for providing rapid update and replication of a website and corresponding pages, having high relevance to search terms on a network comprising:
providing a portal designation that represents one or more domains;
providing a site designation that represent each of said domains and specifying related links for said site;
providing one or more site pages for each of said sites;
providing one or more content items for one or more pages that are associated with said one or more site pages;
providing a plurality of links for said one or more pages; and
utilizing information on said sites and said one or more pages in combination with a plurality of meta data to write a page header, build link menus, generate page content and generate a static HTML file for each of said one or more pages.

10. A method as recited in claim 9 further comprising:
providing one or more entries in a configuration file;
wherein said configuration file is utilized by an http Server; and
wherein said http server utilizes said entries to channel information requests to the website.

11. A method as recited in claim 9, wherein said plurality of meta data provide the relevance needed to place the website and corresponding pages high on a search engine.

12. A method as recited in claim 9, wherein the website and corresponding pages provide informational items about a specific disease.

13. A method as recited in claim 12, wherein said disease is cancer.

14. A method as recited in claim 12, wherein said disease is lung disease.

15. A method in a computing system for managing content that is presented to an end user, comprising:
providing for the addition of one or more new articles to a content repository and categorizing of said new articles into one of more content areas simultaneously; and
providing for the addition of consultation question and answers to said content repository.

16. The method recited in claim 15, wherein said one or more content areas includes a collection of related articles that form an area of a website.

17. The method recited in claim 15, wherein said one or more content areas includes a marquee.

18. The method recited in claim 15, wherein said one or more content areas includes a breaking news collection.

19. The method recited in claim 18, wherein said breaking news collection includes a specified expiration.

20. The method recited in claim 15, wherein said one or more content areas includes an immediate information hotline.

21. The method recited in claim 15 further comprising providing a shopping cart and an advertisement page creation tool and publishing protocol.

22. The method recited in claim 15 wherein said one or more articles is a created and published weekly article alert email newsletter.

23. The method recited in claim 15 wherein said one or more articles includes video in Macromedia Flash Video format converted from standard video.

24. The method recited in claim 15 where said one or more content areas includes interactive medical diagnostic tools.

25. A multi-portal information dissemination system for providing categorized and specific information on pages in websites that are search engine relevant, comprising:
a content management component;
a content delivery engine; and
a website and page replication component.
wherein said content management component categorizes one or more informational items for placement in one or more areas of the websites;
wherein said content delivery engine presents the categorized informational items in said one or more areas of the websites
wherein said content management component also provides for entry and manipulation of content, utilized by said content delivery engine to provide content for the pages; and
wherein said website and page replication component utilizes the categorized informational items to generate the pages and the websites.

26. The multi-portal system of claim 25 further comprising a patient physician consult component, the patient physician consult system comprising:
a secure forum for the presentation of one or more specific questions by a patient to one or more board certified physicians, wherein said specific questions; and
a secure data repository for the storage of a patients current and/or historical medical condition.

27. A method in a computing environment for managing XML fed clinical trial data to facilitate search and presenting said trials, comprising:
utilizing a content management component to classify the clinical trial data for placement;
utilizing a content delivery engine to locate and place the clinical trial data; and
utilizing a website and page replication component to deliver the clinical trial data.

28. A method in a computing system for presenting informational items to a user, comprising:
providing a distinct ladder of menu categories;
providing a grouping of interactive features that are highlighted and located in the middle of the page; and
providing a scrolling informational item marquee on the page, wherein said user may access the expanded view of an informational item by selecting a representation of the informational item from said scrolling marquee.

29. A method in a computing environment for inspecting and monitoring one or more parameters in a Macromedia Flash movie during runtime execution of a website by utilizing a tree view display of said parameters, wherein said parameters are associated with global objects.

30. A method as recited in claim 29, further comprising a trace window to display definable messages.
